(19) United States
(12) Patent Application Publication
(10) Pub. No.: US 2008/0165973 A1
(43) Pub. Date: Jul. 10, 2008

(54) Retrieval and Display of Encryption Labels From an Encryption Key Manager

(76) Inventors: Jose G. Miranda Gavillan, Tucson, AZ (US); Khanh V. Ngo, Tucson, AZ (US); Noah J. Sellars, Tucson, AZ (US)

Correspondence Address: HAMILTON & TERRILE, LLP;IBM Tucson, P.O. BOX 203518, AUSTIN, TX, 78720, US

(21) Appl. No.: 11/621,298

(22) Filed: Jan. 9, 2007

(51) Int. Cl. H04L 9/08; H04L 9/30; G06F 12/14

(52) U.S. Cl. 380/278; 380/44; 713/194

(57) ABSTRACT

A method, system and program are provided for the retrieval of key label codes enabling access to encrypted data in a storage cartridge. An external key manager (EKM) wraps the data key used to encrypt the data with one or more encryption keys to form one or more encryption encapsulated data keys (EEDKs). The EEDK(s), which comprise a key label referencing the EKM containing their respective decryption key, are then stored on the storage cartridge along with the encrypted data. A key label list is generated and updated by querying one or more EKMs to collect the key labels they support. Once the key labels are collected, the existing list is purged and replaced with the new list of collected key labels. A key label is selected from the updated list and its associated EEDK is routed to the EKM containing the decryption key required to extract the data key it contains, which is then used to encode the data on the tape cartridge.

### BACKGROUND OF THE INVENTION

1. Field of the Invention

The present invention relates to the retrieval of valid key labels to have the access to encode data on a storage cartridge.

2. Description of the Related Art

Protecting and securing data is a primary concern that must be addressed when designing information management systems. It is common for data to be continually archived on various storage media, such as tape cartridges or optical disks. When archiving data on tape or other removable storage medium, one security concern is that the tape will be stolen to access the data it contains. Also, if the tape can be mounted into a tape drive through remote commands transmitted over a network, then there is a concern that someone may compromise the system, mount the tape or other storage medium in a drive, and then access the data.

Prior approaches to addressing these issues have included encrypting all or most of the data on the storage media. However, these approaches also have inherent drawbacks that include security weaknesses, implementation challenges and unwieldy complexity. For example, conventional solutions that store the data encryption key in unencrypted form on the same tape as the data it encrypts allow anyone with physical access to the tape to retrieve the data key from the tape and use it to decrypt the data. Furthermore, use of a single key to encrypt all of the data on one or more tape cartridges allows whoever has use of the key to decrypt all of the data comprising the tape cartridge, including data that doesn't belong to the user. Alternatively, multiple data keys can be stored on the tape drive, but key management becomes complicated when using multiple tape drives, as each tape drive has to be able to store all keys that are in use by all tape cartridges in the tape storage library. In addition, using multiple keys for one or more cartridges can lead to a proliferation of keys as the number of authorized users, tape drives, and tape cartridges grows. Conventional encryption systems also maintain the encryption and decryption keys in a central location, and the management and transfer of large numbers of such encryption keys can create additional issues.

One approach to addressing these issues is to encrypt the data keys and store them on the tape cartridge itself For example, when a tape drive requests an encryption key, a random symmetric data key (DK) is generated by an external key manager (EKM). Public/private cryptographic operations are then performed by the EKM to wrap the DK using a key encryption key (KEK), which is typically the public key of an asymmetric key pair. The wrapped data key, along with key label information about what private key is required to unwrap the symmetric key, forms an envelope generally known as an encryption encapsulated data key (EEDK). The EEDK is then typically stored in one or more places on the tape cartridge along with the data it encrypts. To facilitate key management, it is common to implement an encryption policy that assigns a key label, or alias, to a tape cartridge volume serial number (VOLSER) range encrypted by the EEDK. When an encrypted tape is to be read, the tape drive sends the EEDK to the EKM that contains its decryption key. The EKM determines from the EEDK's key label which private key from its keystore to use to unwrap the EEDK and recover the DK. Once the DK is recovered, it is then wrapped with a different key and sent to the tape drive, which decrypts the DK. The tape drive then decrypts the encrypted data on the tape cartridge using the decrypted DK. Similarly, a valid key label for the tape cartridge's VOLSER is retrieved if the tape is to be appended with encrypted data. Once retrieved, the same process is followed to decrypt the EEDK to retrieve the correct DK to encrypt the appended data. However, if multiple EKMs are implemented, each EKM has to be accessed to determine whether it produced the EEDK referenced by its key label.

### SUMMARY OF THE INVENTION

A method, system and program are disclosed for the retrieval of key label codes enabling tamper resistant access to encrypted data in a removable storage medium, such as single tape storage cartridge. In selected embodiments, a data key (such as a symmetric AES key) is used to encrypt the data. The data key is encrypted or wrapped with one or more encryption keys (e.g., a public key from a public/private key pair) by an external key manager (EKM) to form one or more encryption encapsulated data keys (EEDKs). The EEDKs, which comprise a key label referencing the external key manager (EKM) that contains their decrypting key, may then be securely stored in the tape cartridge so that they need not be retained and somehow associated with the each tape cartridge by the tape driver or host system. The EEDK(s) are encrypted in a session encrypted data key (SEDK) and conveyed to the tape drive, where they are decrypted. The EEDK(s) are then stored in one or more places on the storage cartridge and the decrypted data key is used by the tape drive to encrypt data on the tape cartridge.

In selected embodiments, a tape library manager generates an updated key label list by querying one or more EKMs to collect the key labels they currently support. Once all key label updates have been received from the EKMs, the tape library manager purges its local key label list and refreshes the list with a global update of all current and valid key labels provided by the EKMs. A key label is then selected from the updated list and its associated EEDK is routed to the EKM containing the decryption key (e.g., the private key from the public/private key pair) to extract the data key it contains. The extracted data key can then be used to encode data on the tape cartridge.

In one embodiment, access to the encrypted data is changed without re-encrypting the underlying data, also known as rekey. The rekey process of changing the asymmetric Key Encrypting Key (KEK) that protects the Data Key (DK) stored on an already encrypted tape, thereby allowing different entities access to the data. In this embodiment, the original EEDK comprising the original key labels used to encrypt the tape cartridge is rewritten on the tape cartridge using the new EEDK comprising the new key labels. Thus, access to decrypt the tape cartridge is now only by the new EEDK comprising the new key labels.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 illustrates a data storage cartridge with a cartridge memory and a tape medium;

FIG. 2 is a generalized block diagram of a computing environment in which a tape cartridge and tape drive are implemented;

FIG. 3 is a logical flowchart of the steps used to encode and store data;

FIG. 4 is a logical flowchart of the steps used to read and decode stored data;

FIG. 5 illustrates a tape format used to store encrypted data;

FIG. 6 illustrates a key storage architecture for storing encrypted data;

FIG. 7 illustrates logic to securely manage keys in the storage architecture of FIG. 6;

FIG. 8 is a logical flowchart of the implementation of a key label list update system;

FIGS. 9a-b illustrate a user interface to a key label list management system used to update key label lists, and;

FIGS. 10a-b illustrate a user interface to key label management system used to re-key a tape cartridge.

### DETAILED DESCRIPTION

A method, system and program are disclosed for the retrieval of key label codes enabling access to encrypted data in a storage cartridge. In selected embodiments, a data key is encrypted or wrapped with one or more encryption keys by an external key manager (EKM) to form one or more encryption encapsulated data keys (EEDKs). The EEDK(s), which comprise a key label referencing the external key manager (EKM) that contain their decryption key, are then stored in one or more places on the storage cartridge and the decrypted data key is used by the tape drive to encrypt data on the tape cartridge. In selected embodiments, a tape library manager generates an updated key label list by querying one or more EKMs to collect the key labels they support. Once the key labels are collected, the existing list is purged and replaced with the new list of collected key labels. A key label is selected from the updated list and its associated EEDK is routed to the EKM containing the decryption key required to extract the data key it contains, which is then used to encode the data on the tape cartridge. In another embodiment, a tape library manager generates an updated key label list by querying one or more EKMs to collect the key labels they support. Once the key labels are collected, the existing list is purged and replaced with the new list of collected key labels. New key labels are selected from the updated list and its associated EEDK is routed to the EKM containing the decryption key required to extract the data key it contains, which is then used to re-encode the EEDKs on the tape cartridge. Thus, only allowing access to the encrypted data via the new key labels and the previous key labels access to the encrypted data is revoked.

Various illustrative embodiments of the present invention will now be described in detail with reference to the accompanying figures. It will be understood that the flowchart illustrations and/or block diagrams described herein can be implemented in whole or in part by dedicated hardware circuits, firmware and/or computer program instructions which are provided to a processor of a general purpose computer, special purpose computer, or other programmable data processing apparatus to produce a machine, such that the instructions (which execute via the processor of the computer or other programmable data processing apparatus) implement the functions/acts specified in the flowchart and/or block diagram block or blocks. In addition, while various details are set forth in the following description, it will be appreciated that the present invention may be practiced without these specific details, and that numerous implementation-specific decisions may be made to the invention described herein to achieve the device designer's specific goals, such as compliance with technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art. Various illustrative embodiments of the present invention will now be described in detail below with reference to the figures.

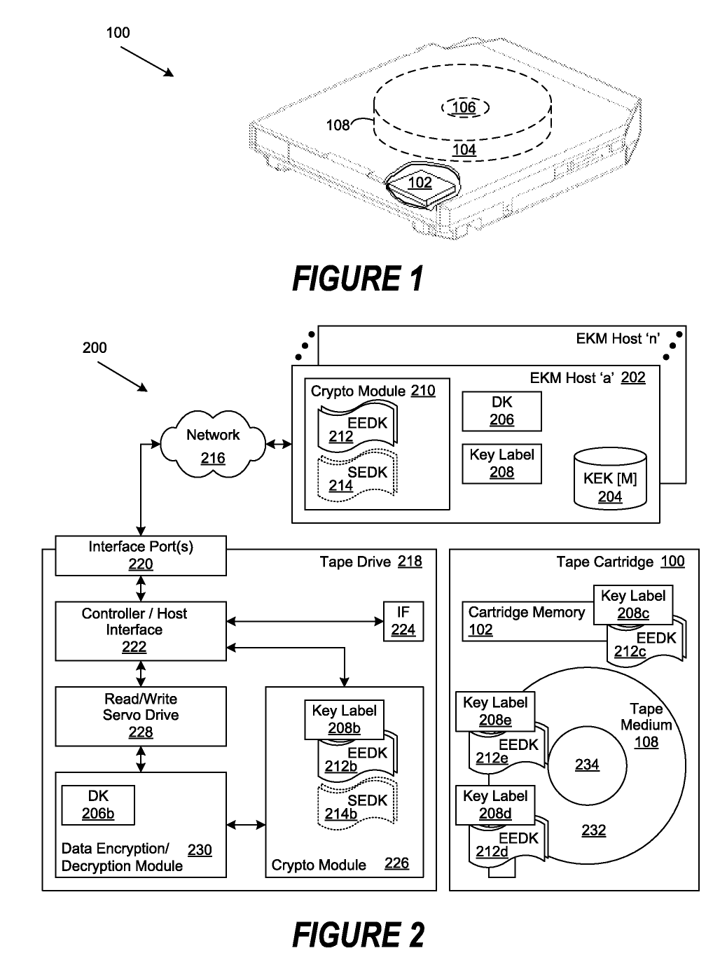

Referring to FIG. 1, a data storage cartridge 100 is illustrated which includes a non-volatile read/writable cartridge memory (CM) circuit 102 (shown in cutaway) and a rewritable storage media 108, such as a high capacity single reel of magnetic tape (shown in phantom) wound on a hub 106 of a reel 104. The cartridge memory 102 is a passive storage device that includes a transponder that provides a contactless interface, and is used to hold information about that specific cartridge, the medium in the cartridge, and the data on the medium. Examples of magnetic tape cartridges comprise a cartridge based on LTO (Linear Tape Open) technology, such as the IBM TotalStorage LTO Ultrium Data Cartridge, and a cartridge based on IBM's 3592 technology, such as the IBM 3592 Enterprise Tape Cartridge. As will be appreciated, the tape cartridge 100 may be a magnetic tape cartridge having dual reel cartridges (in which the tape is fed between reels within the cartridge) or single reel cartridges, such as illustrated in FIG. 1, in which the media 108 is wound on a reel 104 within the cartridge 100. For example, when the cartridge 100 is loaded, the tape is fed between the cartridge reel and a take up reel (not shown). While exemplary tape cartridges based on the LTO and 3592 formats have been described, it will be appreciated that the description is not limited by tape format. Examples of other tape formats include DLT, SDLT, 9840, 9940, T100000, AIT and the like. Additionally, while the description provided herein is with reference to magnetic tape cartridges, it will be appreciated that data storage cartridges may be implemented with magnetic tape, optical tape, optical or magnetic disk, or other forms of rewritable storage media. Likewise, some tape formats do not include cartridge memories (e.g., 3590), while others have a cartridge memory requiring contact (e.g., AIT).

Referring to FIG. 2, a computing environment is illustrated in which a tape cartridge 100 and tape drive 218 are implemented in combination with an external key manager (EKM) 202 as a cartridge handling system 200. It will be appreciated that the external key manager may be a host computer (acting alone or in combination with a proxy control unit), a key management appliance (acting alone or in combination with a proxy library), or the like. One example implementation of such a cartridge handling system 200 would be a magnetic tape data storage system formed from the combination of an IBM 3592 Model E05 Encrypting Tape Drive and the IBM 3592 Enterprise Tape Cartridge subsystem.

In the illustrated example, the EKM/host system 202 includes a host application (not shown), such as a backup program, that transfers data to the tape drive 218 to sequentially write to the tape cartridge 100, such as by using the Small Computer System Interface (SCSI) tape commands to communicate I/O requests to the tape drive 218, or any other data access command protocol known in the art. As will be appreciated, the EKM/host system ‘a’ 202 may be constructed from one or more servers (e.g., the EKM may reside on one server and any application which is reading and writing data to the drive may reside on another server). Similarly, multiple EKMs (e.g., EKM ‘a’ through EKM ‘n’) 202 may be implemented for redundancy, distribution of work load, or for other reasons. However implemented, the EKM/host(s) 202 includes data key generation functionality for generating a data key (DK) 206 for use in performing data encryption though this functionality may also be provided in the drive 218 or even externally to the system 200. In addition, the EKM/host 202 includes a public key crypto module 210 that is used to form a session encrypted data key (SEDK) 214 from the data key 206, and then to securely pass the SEDK 214 to the tape drive 218 as part of a secure key exchange. The public key crypto module 210 also securely encrypts the DK 206 to form one or more EEDKs 212 (as indicated by the stacked keys). In various embodiments, the public key crypto module 210 uses a predetermined public key encryption technique (such as RSA or ECC) to generate EEDK(s) 212 from DK(s) 206. For example, the public part of a public/private key pair that is retrieved from a key store 204 (which may or may not reside locally with EKM/host 202) may be used to wrap the data key 206 into its encrypted EEDK form. The encrypted EEDK form includes not only the encrypted data key DK itself, but also other structural information, such as a key label 208, which identifies the public/private key pair that is used to wrap the data key 206. Once a public key from the key store 204 is used to generate an EEDK 212, the identifying structural information in the EEDK 212 (e.g., the key label 208) can be later used by the key module 210 or EKM 202 as an index or reference to the public/private key pair in the key store 204 to retrieve the private key from the key store 204 when the EEDK 212 needs to be processed to unwrap the DK 206.

The tape drive 218 may connect with the host 202 through a direct interface (such as an SCSI, Fibre Channel (FCP), etc., in the case if the tape drive 218 is connected to the host 202) or may connect over a data channel or network 216 (such as a Local Area Network (LAN), Storage Area Network (SAN), Wide Area Network (WAN), the Internet, an Intranet, etc.). It will be appreciated that the tape drive 218 may be enclosed within the host system 202 or may be a standalone unit or in a tape library system (not shown), which may include one or more tape drives, one or more storage units to store multiple tape cartridges, and a mechanical system (commonly referred to as an accessor) to transfer the tape cartridges between the storage unit(s) and the tape drive(s). As illustrated, the tape drive 218 includes a memory circuit interface (IF) 224 for reading information from, and writing information to, the cartridge memory 102 of the data storage cartridge 100 in a contactless manner. In addition, a read/write servo drive system 228 is provided for reading information from, and writing information to, the rewritable tape media 108. The read/write servo drive system 228 controls the movement of a servo head (not shown) relative to the magnetic tape medium 108 by moving the magnetic tape medium 108 across the servo head at a desired velocity, and stops, starts and reverses the direction of movement of the magnetic tape.

A control system (or controller) 222 in the tape drive 216 communicates with the memory interface 224 and the read/write system servo drive 228. To receive commands and exchange information for operating the cartridge handling system 200, the controller 222 also acts as a host interface to communicate over one or more ports 220 with one or more external key management (EKM) subsystems 202 (such as a host computer, library or external key management appliance). In addition, a crypto module 226 and data encryption/decryption module 230 are provided in the tape drive 218 for securely encrypting and storing data to the tape cartridge 100 and for securely retrieving and decrypting data stored on the tape cartridge 100. In operation, the data encryption/decryption module 230 performs the actual data encryption and decryption (such as by using the Advanced Encryption Standard encryption algorithm) using a data key having any desired key length (e.g., 128 or 256-bit data key length), and may also perform other encoding functions, such as data compression and decompression and data buffering. The crypto module 226 controls the data encryption/decryption module 230 by securely exchanging data key (DK) 206b and its associated key label 208b using the SEDK 214b which is received from the EKM 202 (where it is originally generated as SEDK 214). At the crypto module 226, the DK 206b is extracted from the SEDK 214b, and is sent to the data encryption/decryption module 230 where it is used to encode/decode the input data stream. In addition, the crypto module 226 assembles, validates, distributes, stores and retrieves one or more associated EEDK(s) 212b (where the letter suffix “b” in the reference numeral indicates that the EEDKs 212 and 212b are logically identical, though physically distinct copies). While the modules 226, 230 may be implemented with any desired combination of hardware and/or software, the data encryption/decryption module 230 may be implemented with an ASIC or FPGA circuit, while the crypto module 226 may be implemented with one or more drive firmware modules that include a microprocessor and microcode stored in a code memory.

As described herein, the cartridge handling system 200 performs a variety of functions, including but not limited to, encrypting data to be stored on the cartridge 100 using a data key (such as an AES encryption key); using public key cryptography techniques to wrap the data key to form one or more encrypted data keys; writing and reading the encrypted data and encrypted data key(s) to and from the tape cartridge media; and unwrapping the encrypted data key such that the unwrapped key can decrypt the stored encrypted data. In this way, the cartridge handling system 200 provides a distributed key store which allows different user's data to be separately and uniquely encrypted on a single tape cartridge 100. For example, at least a first EEDK 212 is generated for local use by using a public key of the local key manager to wrap the data key 206, and the EEDK 212 is then transferred via the tape drive 218 (where it may be temporarily stored as 212b) for storage on the tape cartridge 100 at one or more predetermined locations, as indicated at 212c, 212d and 212e. As a result, the transferred EEDK 212b may be stored in the cartridge memory 102 and/or one or more non-user data areas of the tape media 108, such as a read-in area 232 or an end of tape area 234. Although only a single copy of the EEDK 210 is required to be stored on the tape cartridge 100, security and reliability are enhanced by using one or more non-user areas 232, 234 of the tape 108 to store multiple (e.g., three or more) copies of the EEDK 212 thereby allowing deletion of the EEDKs 212, 212b at the EKM 202 and tape drive 218. Since the only non-volatile copies of the EEDKs are stored within the tape cartridge 100, multiple copies of the EEDKs (212c, 212d, 212e, etc.) provide multiple ways to access the EEDK(s) and thus the data key 206 in the cases where one or more copies of the EEDKs cannot be read or otherwise processed due to errors or degraded media or drive conditions.

When a plurality of EEDKs 212 are generated from a single data key 206—such as when a second EEDK is generated for a remote user (e.g., a business partner) by using a public key of the remote user to wrap the data key 206—the plurality of EEDKs 212, and their associated key labels 208, are transferred via the tape drive 218 for storage on the tape cartridge 100 at one or more locations (as indicated by the copies of the EEDKs 212c, 212d and 212e that are stored in one or more non-user data areas 232, 234 of the tape media 108 and/or the cartridge memory 102). By storing multiple EEDKs on the tape cartridge 100 in specially designated locations (such as the cartridge memory 102 or outside of the tape's user data area), the tape cartridge 100 can have one EEDK wrapped for local use and another for remote exchange. In theory, any number of different EEDKs could be stored, provided there is storage space for them.

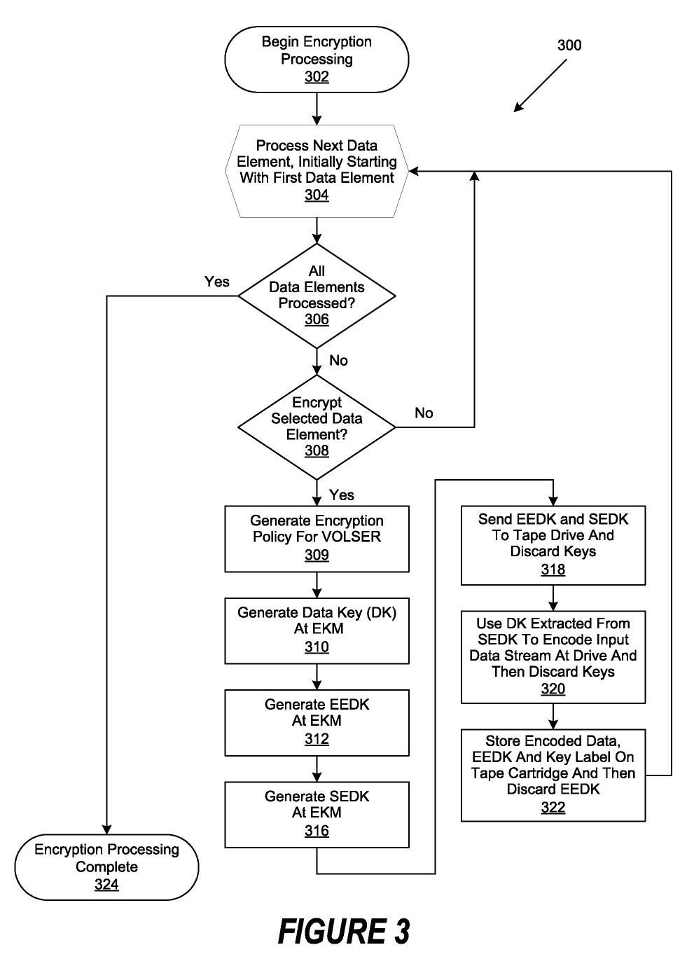

To illustrate how data may be securely encoded and stored on a removable tape cartridge that has not previously acquired its own encrypted data keys, reference is now made to the process flow depicted in FIG. 3 and the cartridge handling system 200 depicted in FIG. 2. Encryption processing begins in step 302, starting with the next data element to be encrypted in step 304, which initially is the first data element on the tape cartridge 100. If all data elements on the tape cartridge 100 have been processed, then encryption processing ends with step 324. To facilitate key management, an associated encryption policy is generated in step 309 to facilitate key management. The encryption policy comprises the tape cartridge volume serial number (VOLSER) range encrypted by the EEDK, one or more key labels, and a key mode for each key label. The key mode comprises a method by which an EKM identifies the public/private keys used to encrypt the DK and generate the EEDK. Choices for key modes include a default label generated by the EKM, a clear label where the EEDK is specified by the key label in cleartext, and a hash label where the EEDK is referenced by a computed value corresponding to its associated public key. It will be appreciated that the clear label, readable in clear text, facilitates management of key stores used to encrypt tape cartridges as it can provide easily-readable references to which entity created or can read the tape. It will likewise be appreciated that hash labels allow the associated keys to be referenced by content, which facilitates locating the associated KEK if the key labels have been changed, removed, or implemented under different names.

Otherwise, if it is determined in step 306 that the selected element is not to be encrypted, then the process is repeated beginning with the next element to be encrypted in step 304. Otherwise, a DK 206 is generated at the EKM 202 in step 310 and is then made available in encrypted form with its associated key label 208 to the tape drive 218 before the write process begins. To this end, a secure key exchange is used to transfer the DK 206 and its key label 208 in encrypted form to the tape drive 218 for purposes of enabling the tape drive encryption process.

While a variety of different encryption techniques may be used, an initial key generation process at the EKM 202 encrypts the DK 206 to form one or more EEDKs 212 using an encryption method, such as a pubic key cryptographic method in step 312. It is unimportant whether the encryption method is known outside of the EKM 202. In a selected embodiment, the EEDK 212 creation process in the EKM 202 uses asymmetric encryption by performing RSA 2048-bit encryption of the DK 206 with the public part of a public/private key pair to render the data key 206 within the EEDK 212 completely secure to any entity who does not possess the private part of the key pair. To associate the generated EEDK(s) 212 with the public/private key pair used to encrypt the DK 206, structural information (e.g., key label 208) about the public/private key pair is included in each generated EEDK 212 by the EKM 202 which can be extracted from the EEDK 212 for future access to the data key 206 and consequently the encrypted data itself.

At this time, a secure key exchange is established to encrypt the data key DK 206 with a session key (e.g., the public key from the tape drive 218), thereby generating a session encrypted data key (SEDK) 214 in step 316, which can be securely passed, along with the EEDK 212 and its associated key label 208, to the tape drive 218 in step 318. Once the EKM 202 sends the encrypted data keys to the tape drive 218, the DK 206, key label 208, and encrypted data key(s) 212, 214 may be discarded by the EKM 202 in step 318. As will be appreciated, there are several methodologies which may be used for secure key exchanges, including wrapping the DK 206 in a session key, though other techniques may be used, including but not limited to RSA, Diffie-Hellman (DH), elliptic curve Diffie Hellman (ECDH), Digital Signature Algorithm (DSA), elliptic curve DSA (ECDSA), etc. The session key may come from the tape drive 218 or the host 202.

Upon transfer to the tape drive 218, the EEDK(s) 212b and the SEDK 214b are stored in the crypto module 226. The tape drive 218 decrypts the SEDK 214b with its private session key to produce the DK 206b, which is used to set up the encryption hardware module 230. At any point after the encryption hardware module 230 is set up, the SEDK 214b may be discarded from the tape drive 218 in step 318. The tape drive also writes the EEDK(s) 212b to the tape cartridge 100 as part of set up or any point thereafter, and begins encrypting data using the extracted DK 206b in step 320. When writing the EEDK(s) 212b to the tape cartridge 100, the tape drive 218 stores multiple copies of the EEDK 212c-e in a plurality of locations, such as one or more non-user data areas 232, 234 of tape 108 and in the cartridge memory 102 in step 322. In selected embodiments, the EEDK(s) are written to the tape cartridge 100 before the encoding or writing of data since such writing may comprise many gigabytes. Also, by recording the EEDKs 212c-e first, the host system that encounters an error condition can retrieve some portion of the written encoded data by using the previously stored EEDK 212c-e for that encoded data. While the EEDK(s) 212b could be discarded from the tape drive after being written to the tape cartridge 100, they may be retained in the tape drive 218 in a volatile fashion for as long as the cartridge is loaded in the drive. Once the input data stream is encrypted and the tape drive 218 has written the encoded data to the tape 108, the tape drive 218 discards the DK 206b in step 322. Once the encoded data and EEDK(s) 212c-e are stored to the tape cartridge 100, the tape drive 218 discards the encoded data and the EEDK(s) 212b in step 322. The data encryption process then repeats itself, beginning with the next element to be decrypted in step 304.

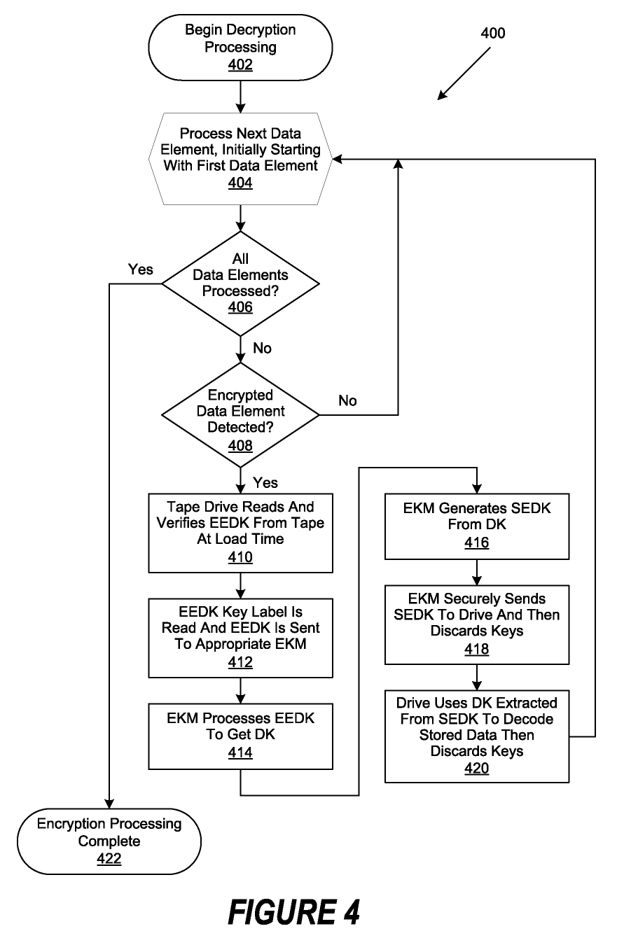

An example of how data may be securely decoded and read from a removable tape cartridge will now be described with reference to the process flow depicted in FIG. 4 and the cartridge handling system 200 depicted in FIG. 2. Decryption processing begins in step 402, starting with the next data element to be decrypted in step 404, which initially is the first data element on the tape cartridge 100. If all data elements on the tape cartridge 100 have been processed, then decryption processing ends with step 422. Otherwise, if it is determined in step 406 that the selected element is not to be decrypted then the process is repeated beginning with the next element to be decrypted step 404. Otherwise, during the tape cartridge load process, the tape drive 218 recognizes that a tape 108 has encryption data on it by detecting the existence of EEDKs 212 or other control indicators on the tape cartridge 100 in step 408. This may be done at the tape drive 218 in step 410 by reading the EEDK(s) 212c from cartridge memory 102 or by reading and verifying the EEDK(s) 212d, 212e from a non-user data area(s) 232, 234.

To enable the tape device hardware decryption and/or encryption process(es), a key exchange must occur in order to retrieve and decrypt the stored EEDKs 212c-e for purposes of extracting the correct decryption data key. However, when the data keys are not retained or stored on the tape drive 218 or the EKM 202, the EEDKs 212c-e must be used to reacquire the data key 206 at the EKM 202, which then securely transfers the DK 206 to the tape drive 218. For example, after the tape cartridge 100 is loaded and the EEDKs 212c-e are stored as EEDK(s) 212b in the crypto module 226 of the tape drive 218, the EEDK key labels are read to determine which EKM 202 generated them. Once determined, the EEDK(s) 212b are sent to the appropriate EKM 202 in step 412. Once the EEDK(s) 212b are transferred to the appropriate EKM 202, the EKM 202 determines their validity by extracting key label 208 information from the EEDK 212 and searching the key store 204 for a match, in which case the associated private key is output from the key store 204 and used to decrypt the EEDK 212, thereby extracting the data key DK 206 in step 414. The data key DK 206 is then securely wrapped in the tape drive's session key to generate the session encrypted data key SEDK 214 in step 416. Using any desired secure key exchange protocol, the EKM 202 passes the SEDK 214 to the tape drive 218 where it is stored as the SEDK 214b, at which time the EKM 202 discards the SEDK 214 in step 418. The tape drive 218 then decrypts the SEDK 214b with its private session key to produce the DK 206b, which is used to set up the decryption hardware module 230 in step 420. Once again, the tape drive 218 can discard the SEDK 212b at any point after the decryption hardware module 226 is set up, even before the stored data is decrypted. Continuing in step 420, the decryption hardware module 230 decodes the encrypted data element, and when decoding is completed, the process repeats, beginning with the next data element to be decrypted in step 404.

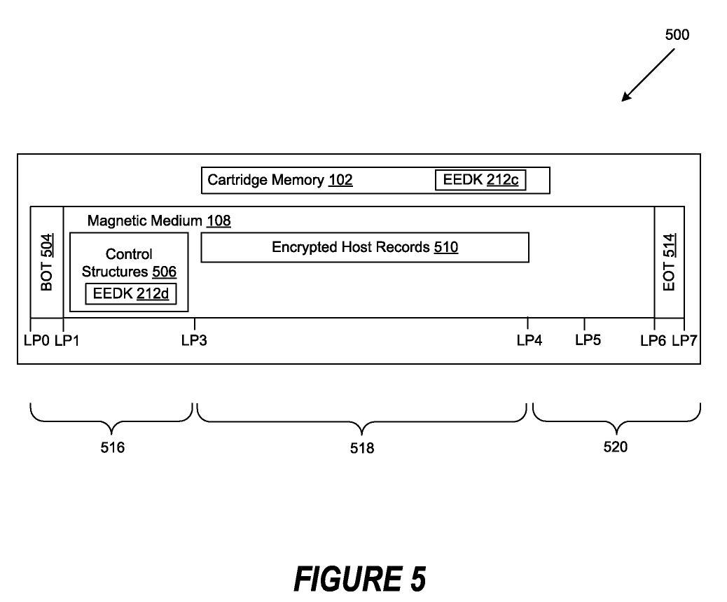

As illustrated in FIG. 5, the EEDKs 212c, 212d may be stored in multiple places by using the non-User Area parts of tape cartridge 500 to store the EEDK(s). For example, an EEDK 212c may be stored in the cartridge memory 102. In addition, the EEDK(s) may be stored in special non-user data set regions 516, 520 of the magnetic medium 108 that are designed for holding this type of information. Such tape regions include beginning of tape (BOT) 504 before the User Data area (i.e. before LP3) and end of tape (514) after it (i.e. after LP4). Thus, for each encrypted tape cartridge 500, an internal control storage area 506 is provided on magnetic medium 108 which allows the storage of EEDK structures 212d if this structure is provided by the external key manager.

When the EEDKs 212c, 212d are stored in non-user areas, the data key wrapping technology described herein may be used to change access to the encrypted data records 510 without re-encrypting the underlying data. By changing the access to the encrypted data key as described in greater detail herein, a variety of additional cartridge control features are provided, such as adding an EEDK to the cartridge, re-keying a cartridge, and shredding a cartridge. In particular, a DK can be encrypted with a first wrapping key (e.g., a public key from a public/private key pair) to form a first EEDK and then generating a first encryption policy comprising a first key label further comprising a first key mode. Subsequently, additional access to the DK can be provided by encrypting the DK with a second wrapping key to form a second EEDK and by generating a second encryption policy comprising a second key label further comprising a second key mode. With this approach, and by storing the new EEDK's outside of the user data area of the tape volume, multiple users can be added and enabled to access the encrypted data without re-encrypting the data. It will therefore be apparent that parallel access to the DK 206 (and therefore the data on the tape) is provided to anyone possessing the necessary unwrapping key (e.g., the private key from the public/private key pair) associated with any of the EEDK structures stored on the cartridge.

Another cartridge control feature is that a cartridge can be re-keyed when the KEK used to encrypt the EEDK expires or to change user access by removing a first user and adding a second user. This may be accomplished by decoding a first EEDK on the cartridge using an appropriate unwrapping key to extract the underlying data key DK, re-wrapping the DK using a different wrapping key (e.g., a new public key from a public/private key pair that belongs to a second user) to generate a new EEDK with a new key label, and re-storing the new EEDK back on the tape to overwrite the first EEDK. The result is that access is removed for anyone who previously could decode the first EEDK, while enabling access for anyone who could decode the new EEDK, all without having to re-write the data and encrypt it with a different data key.

Yet another cartridge control feature is that cartridge data access can be permanently prevented, effectively “shredding” the cartridge data. This may be accomplished by deleting or erasing the EEDK structures from the tape. Since the EEDK structures are the only repository for the data key needed to decrypt the cartridge data, the data may never be decrypted. Erasing the EEDK structures is much faster (on the order of 2-3 minutes versus 1-2 hours) and actually more secure then erasing all the data from the tape. Another advantage is that the wrapping and unwrapping keys do not need to be deleted from the key store to prevent readability of the tape, since the EEDK(s) have been deleted. Also, EEDK erasure can be performed more securely (e.g., using multiple erase passes with random patterns), more easily and more quickly then a secure erase of all encrypted data.

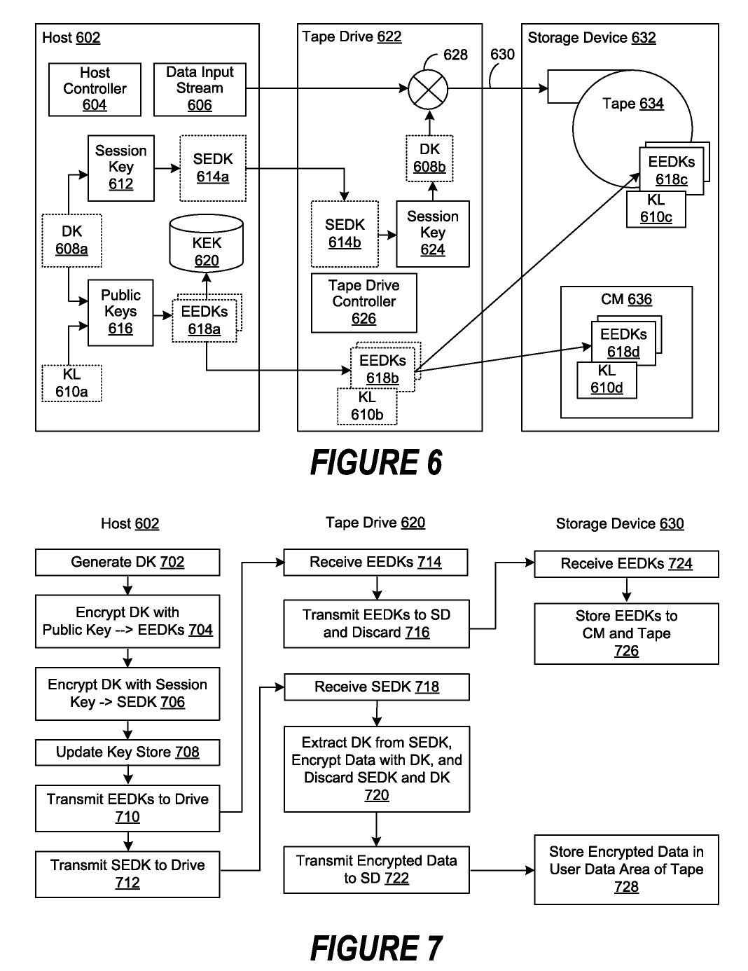

FIG. 6 shows a key storage architecture for storing encrypted data to illustrate how the various keys may be deployed in the host 602, tape drive 622 and storage device 632. The host 602 generates a unique data key (DK) 608a (e.g., a unique 256-bit AES key) to encode and decode data on at least one storage device. The host 602 also includes a session key 612 that is capable of encrypting data that can be decrypted by a session key 624 at the tape drive 622. For example, the session keys 612, 624 can be generated as a public/private key pair using public key encryption algorithms known in the art. The host 602 further includes one or more public keys 616 that are capable of encrypting the data key 608a with a corresponding key label (KL) 610a comprising its associated key mode into one or more encryption encapsulated data keys (EEDKs) 618a that can be decrypted by the appropriate private key that matches the public key 616.

To extract a data key from the EEDK 618a (upon its subsequent receipt), the generated EEDK 618a includes structural information (such as key label 610a referencing the key encrypting key 620) that can be used to reference or lookup the key encrypting key 620 and its corresponding private key in the key store 620 that can be used to decrypt the received EEDK. In addition or in the alternative, the key store 620 stores information identifying the EEDKs generated by the host 602 so that the identifying information is associated (e.g., by using a table) with the public key used by the host to generate the EEDK. Finally, the host 602 includes a host controller 604 that handles I/O requests for directing a data input stream 606 to the tape drive 622. Once the DK 608a, KL 610a, and encrypted data keys 614a, 618a are used, they may be discarded from the host 602, as indicated by the dashed lines in FIG. 6.

At the tape drive 622, the received SEDK 614b is stored and decrypted by the session key 624 to generate a local copy of the DK 608b, all under control of the tape drive controller 626. The DK 608b is then combined in an encryption circuit 628 with the input data stream 606 from the host 602, thereby generating an encrypted data stream 630 that is stored in the tape media 634. In addition, the received EEDK(s) 618b and their associated KLs 610b are forwarded to the storage device 632 where they are collectively stored to one or more locations 618c, 610c in the non-user data portion of the tape 634, and to predetermined location(s) 618d, 610d in the cartridge memory 636. Once the DK 608b and encrypted data keys 614b, 618b are processed at the tape drive 622, they may be discarded, as indicated by the dashed lines.

FIG. 7 illustrates logic to securely manage keys in the storage architecture of FIG. 6 using the control logic implemented in the host controller 604 and tape drive controller 626 for securely managing and storing keys and encrypted data in one or more storage devices. When the host 602 generates a data encryption key DK (block 702), it is encrypted with one or more public keys (e.g., a public key of the host or a business partner) to form one or more key-wrapped data keys (a.k.a. EEDKs) (block 704). In certain implementations, the host 602 obtains the public key from a third party, or alternatively, the host 602 can generate the public/private key pair itself. The host 602 also encrypts the DK 608 with a public session key (e.g., the tape drive's public key) to form a session encrypted data key (SEDK) (block 706). While generally not required, in some embodiments, the key store or related mechanism may be updated to correlate or track the wrapping key(s) used in forming of any EEDK(s) (block 708). The encrypted data keys (EEDKs and SEDK) are transmitted to the tape drive 622 and discarded from the host 602 (blocks 710, 712).

Upon receiving the EEDKs for a storage device 632 (at block 714), the tape drive controller 626 writes (at block 716) the encrypted data keys (EEDKs) to the storage device 634 and then discards the EEDKs. In addition, once the session encrypted data key (SEDK) is received at the tape drive (block 718), the tape drive controller 626 decrypts the SEDK to extract the data key using the tape drive private session key that corresponds to the public session key, and then uses the extracted DK 608 to encode data being written to the storage device (at block 720). After the data is encoded and stored, the DK and SEDK are discarded and the encoded data is transmitted to the storage device 632 (at block 722). When the EEDKs are received at the storage device (block 724), they are separately stored in multiple locations in the storage device, such as the cartridge memory and the non-user data area of the tape (block 726). In selected embodiments, the EEDK(s) are written to the storage device 632 prior to storing the encrypted data on the storage device (block 728).

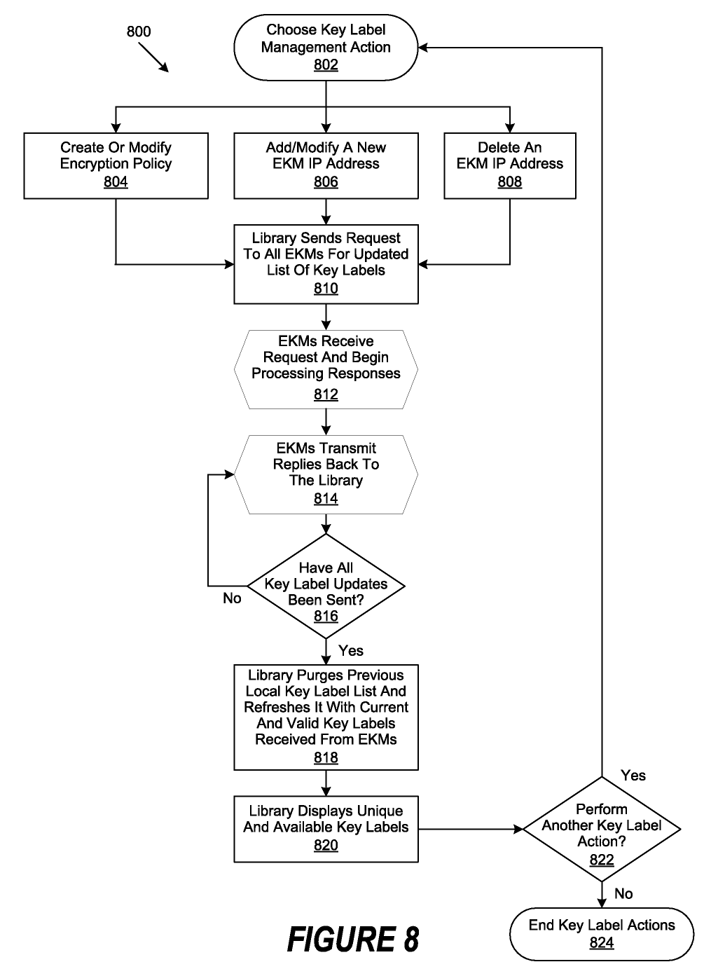

FIG. 8 shows a flow chart of an automated key label management system 800 as implemented in an embodiment of the invention. In step 802 a key label action is chosen, such as creating or modifying an encryption policy in step 804, adding or modifying an external key manager (EKM) IP address in step 806, or deleting an EKM IP address in step 808. Once a key label action 804, 806, 808 is chosen, the tape library manager sends a request in step 810 to one or more predetermined EKMs for a current list of valid key labels referencing private keys comprising their respective keystores. The EKMs receive the key label update request in step 812 and begin processing of their respective responses, which are transmitted back to the requesting tape library manager in step 814. If it is determined in step 816 that the EKMs have not completed their key label updates, then the process continues in step 814.

Once it has been determined in step 816 that all key label updates have been received from the EKMs, the tape library manager purges its local key label list in step 818 and refreshes the list with a global update of all current and valid key labels provided by the EKMs. The refreshed key label list is then displayed in step 820 showing available and unique key labels. If it is determined in step 822 to perform additional key label update action, then the process is repeated beginning with step 802. Otherwise, key label update actions end in step 824.

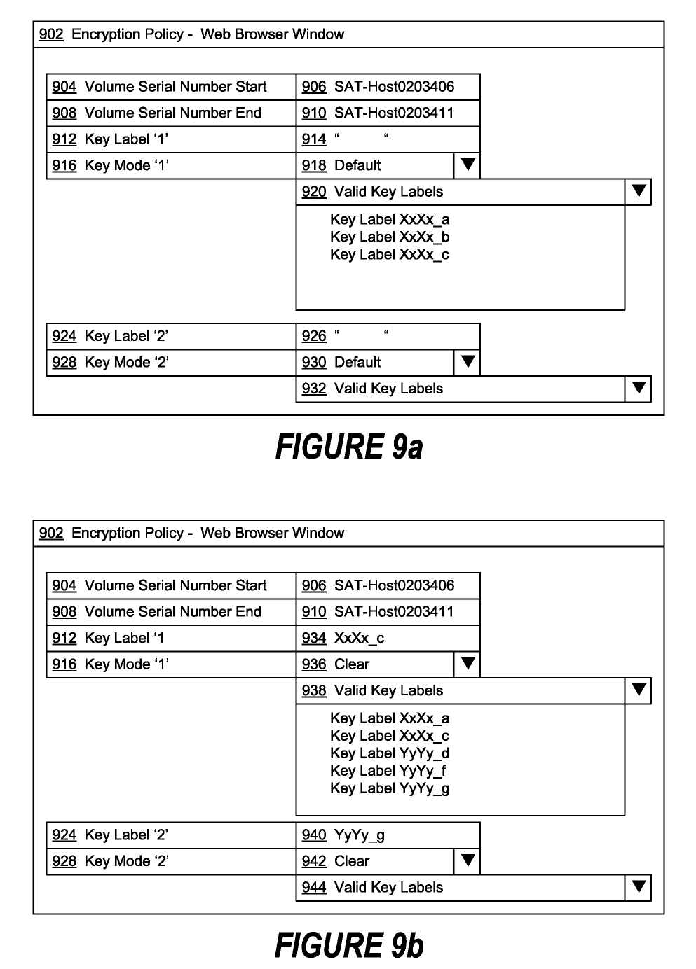

FIGS. 9a-b show an encryption policy user interface screen 902 as implemented in a web browser to update key label lists in accordance with an embodiment of the invention. In this embodiment, FIG. 9a depicts encryption policy user interface screen 902 comprising a beginning volume serial number (VOLSER) 904 displayed in window 906 and an ending VOLSER 908 displayed in window 910. Key label ‘1’ 912 of the VOLSER range displayed in windows 906, 910 is currently blank in window 914 and key mode ‘1’ 916 is currently unchosen as displayed in window 918. In selected embodiments of the invention, key modes include a default label generated by the EKM, a clear label where the EEDK is specified by the key label in cleartext, and a hash label where the EEDK is referenced by a computed value corresponding to its associated public key. It will be appreciated that the clear label, readable in clear text, facilitates management of key stores used to encrypt tape cartridges as it can provide easily-readable references to which entity created or can read the tape. It will likewise be appreciated that hash labels allow the associated keys to be referenced by content, which facilitates locating the associated KEK if the key labels have been changed, removed, or implemented under different names.

Valid key labels 920 are displayed in a drop-down window and include key labels “XxXx_a”, “XxXx_b” and “XxXx_c”. In one embodiment, the data on the tape cartridge is to be encrypted and a previously generated key label needs to be specified to reference its corresponding EKM, which will generate the required data key for encryption. In this embodiment, the current list of key labels 922 may or may not contain the key labels referencing the EKM required to encrypt the VOLSER range depicted in windows 906, 910. Similarly, key label ‘2’ 924 of the VOLSER range displayed in windows 906, 910 is currently blank in window 926, key mode ‘2’ 928 is currently unchosen as displayed in window 930, and valid key labels 932 are not currently displayed.

FIG. 9b similarly depicts the encryption policy user interface screen 902 after the key label list has been purged and refreshed. The encryption user interface screen 902 comprises a beginning VOLSER 904 displayed in window 906 and an ending VOLSER 908 displayed in window 910. After the key label list has been refreshed, key label ‘1’ 912 of the VOLSER range displayed in windows 906, 910 now shows “XxXx_c” in window 934 as a valid and current choice from the valid key label 938 drop down window. Key mode ‘1’ 916 is now set to ‘clear’ as displayed in window 936. Previously selected key labels 934 have been updated as described in greater detail herein and are displayed in a drop-down window and include key labels “XxXx_a”, “XxXx_c”, “YyYy_d”, “YyYy_f”, and “YyYy_g”. The updated list of key labels 938 signify that previously displayed key label “XxXx_b”, and its related private key, is no longer resident on an associated EKM. Conversely, key labels “YyYy_d”, “YyYy_f”, and “YyYy_g” have been added to the list, and may have been generated by the same EKM that generated key labels “XxXx_a”, “XxXx_c”. Alternatively, key labels “YyYy_d”, “YyYy_f”, and “YyYy_g” may have been generated by a different EKM. Similarly, key label ‘2’ 924 of the VOLSER range displayed in windows 906, 910 now shows “YyYy_g” in window 940 as a valid and current choice from the valid key label 944 drop down window (not show). Likewise, key mode ‘2’ 928 is now set to ‘clear’ as displayed in window 942.

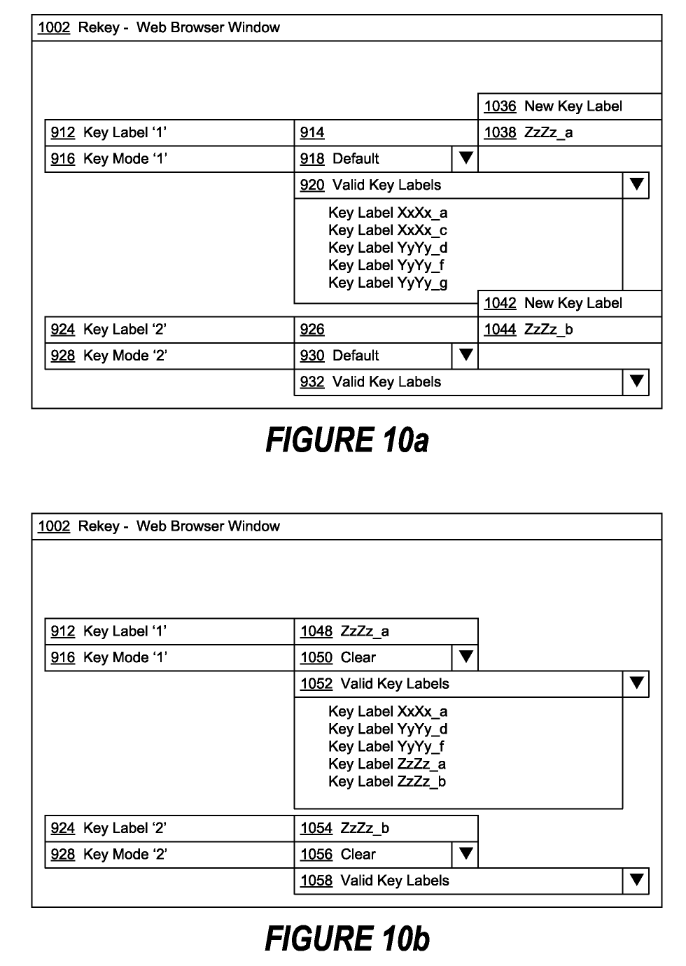

FIGS. 10a-b show an encryption policy user interface screen 902 as implemented in a web browser to re-key a tape cartridge in accordance with an embodiment of the invention. In selected embodiments, the data key wrapping technology described herein may be used to change access to encrypted data without re-encrypting the underlying data. By changing the access to the encrypted data key, a variety of additional cartridge control features are provided, such as adding an EEDK to the cartridge, re-keying a cartridge, and shredding a cartridge. For example, when the DK is encrypted with a first wrapping key (e.g., a public key from a public/private key pair) to form a first EEDK, additional access to the DK can be provided by encrypting the DK with a second wrapping key to form a second EEDK.

In this embodiment, FIG. 10a depicts rekey user interface screen 1002. Key label ‘1’ 912 is currently “XxXx_c” in window 914 and key mode ‘1’ 916 is currently “default” as displayed in window 918. Valid key labels 920 are displayed in a drop-down window and include key labels “XxXx_a”, “XxXx_c”, “YyYy_d”, “YyYy_f” and “YyYy_g”. Similarly, key label ‘2’ 924 is currently “YyYy_g” in window 926, key mode ‘2’ 928 is currently “default” as displayed in window 930, and valid key labels 932 are not currently displayed.

As described in greater detail herein, multiple EEDK structures are created on the cartridge by using different KEKs to wrap the same underlying data key DK. As a result, parallel access to the DK (and therefore the data on the tape) is provided to anyone possessing the necessary unwrapping key (e.g., the private key from the public/private key pair) associated with any of the EEDK structures. In this figure, the new key label window 1036 is opened to create a new key label ‘1’ 920, which is entered in window 1038 as “ZzZz_a”. Similarly, a new key label window 1042 is opened to create a new key label ‘2’ 924, which is entered in field 1038 as “ZzZz_b” and its corresponding new key mode ‘1’ is likewise selected as “clear” in window 1046.

The current key label ‘1’ displayed in window 914 references the EKM that holds the private key required to decode a first EEDK on the cartridge, which results in the extraction of the underlying data key DK. The underlying DK is then re-wrapped using a different wrapping key (e.g., a new public key from a public/private key pair) to generate a new EEDK and a corresponding new key label ‘1’ displayed in window 1038. The new EEDK is then written back on the tape to overwrite the first EEDK. The result is that access is removed for anyone who previously could decode the first EEDK, while enabling access for anyone who could decode the new EEDK, all without having to re-write the data and encrypt it with a different data key.

FIG. 10b similarly depicts the rekey user interface screen 1002 after the key label list has been purged and refreshed after new key labels ‘1’ and ‘1’ have been respectively entered in windows 1038 and 1044 After the key label list has been refreshed, key label ‘1’ “ZzZz_a” in window 1048 as a valid and current key label in the previously selected key labels 1052 drop down window. Key mode ‘1’ 916 is now set to ‘clear as displayed in window 1050. Valid key labels 1052 have been updated as described in greater detail herein and are displayed in a drop-down window and now include key labels “XxXx_a”, “YyYy_d”, “YyYy_f’, and the newly created key labels “ZzZz_a”, and “ZzZz_b”. The updated list of key labels 1050 signify that key labels “XxXx_c” and “YyYy_f’, as well as their related private keys, are no longer resident on their associated EKMs. Conversely, key labels “ZzZz_a”, and “ZzZz_b” have been added to the list, and may have been generated by the same EKM that generated key labels “XxXx_a”, “YyYy_d”, and “YyYy_f”. Alternatively, key labels “ZzZz_a”, and “ZzZz_b” may have been generated by a different EKM. Similarly, new key label ‘2’ 924 now shows “ZzZz_b” in window 1054 as a valid and current choice from the valid key label 1058 drop down window (not shown). Likewise, key mode ‘2’ 928 is now set to ‘default’ as displayed in window 1056.

The foregoing description has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification and example implementations provide a complete description of the manufacture and use of the composition of the invention. Since many embodiments of the invention can be made without departing from the spirit and scope of the invention, the invention resides in the claims hereinafter appended.

1. A method for enabling access to encrypted data stored on a storage cartridge, comprising:
generating a first data key for encrypting data to form encrypted data;
encrypting the first data key with a first key encrypting key to generate a first encrypted key comprising a first key label, where the first key label references an external key manager (EKM) comprising a first decrypting key;
storing the first encrypted key to one or more locations in the storage cartridge, and;
generating a list of a plurality of valid key labels comprising the first key label, where the list of the plurality of valid key labels comprises one or more EKMs, and;
extracting the first data key from the first encrypted key by using the first decrypting key comprising the EKM referenced by the first key label.

2. The method of claim 1, where the first data key and the first encrypted key are generated at an external key manager and are subsequently discarded after the first encrypted key and encrypted data are stored to the storage cartridge.

3. The method of claim 1, where the first key label and the first decrypting key are generated at an EKM, and at least one copy of the first key label and the first decrypting key are stored at the EKM.

4. The method of claim 1, where the storage cartridge comprises a cartridge memory and where at least one copy of the first encrypted key is stored in the cartridge memory.

5. The method of claim 1, where the storage cartridge comprises a storage medium and where at least one copy of the first encrypted key is stored in the storage medium.

6. The method of claim 1, where the storage cartridge comprises a magnetic tape and where the first encrypted key is stored to one or more locations on the magnetic tape.

7. The method of claim 1, where the one or more locations in the storage cartridge comprise non-user data areas.

8. The method of claim 1, where the first key encrypting key and first decrypting key comprise a public key and a private key, respectively, of a public/private key pair.

9. The method of claim 1, where the list of a plurality of key labels comprises key labels that are currently supported by the EKMs they reference.

10. The method of claim 1, where a first encrypted key comprising a first key label and a second encrypted key comprising a second key label may be used to change access to the encrypted data without re-encrypting the underlying data.

11. The method of claim 10, where the first key label references an EKM comprising a first decrypting key operable to decrypt the first encrypted key and extract the first data key, and the second key label references an EKM comprising a second decrypting key likewise operable to decrypt a second encrypted key to extract the first data key.

12. The method of claim 10, where the first key label references an EKM comprising a first decrypting key operable to decrypt the first encrypted key and extract the first data key, which is then re-encrypted with a second key encrypting key to generate a second encrypted key comprising the second key label.

13. A data storage drive comprising:
a read/write drive for reading data from and writing data to a storage medium housed in a data storage cartridge loaded in the data storage drive; and
a controller coupled to the read/write drive that is configured to process a first data key, a derived data key, and one or more encryption encapsulated data keys by:
encoding data with the first data key to form encoded data;
directing the read/write drive to:
store the encoded data on the storage medium;
store the first encrypted key comprising a firs valid key label to one or more locations on the storage medium;
retrieve the first encrypted data key comprising a first key the valid label from one or more locations on the storage medium, and;
decoding the stored encoded data with the extracted first data key to form unencoded data.

14. The data storage drive of claim 13, where the storage medium comprises a cartridge memory housed in the data storage cartridge.

15. The data storage drive of claim 13, where the storage medium comprises a magnetic tape housed in the data storage cartridge and where the controller is configured to direct the read/write drive to store each of the first encrypted data key in one or more locations on the magnetic tape.

16. The data storage drive of claim 13, where the controller is configured to:
direct the read/write drive to read at least a first encrypted data key comprising valid key label from a data storage cartridge; and
forward the first encrypted data key to a key manager referenced by the valid key label to be unwrapped with a first decrypting key to extract a data key which can be used at the data storage drive to decode encrypted data stored on the data storage data cartridge.

17. A storage system for enabling secure access to data in a removable storage cartridge, comprising:
at least one key manager for generating a data key, wrapping the data key with an encrypting key to generate an encrypted data key with an associated valid key label, and subsequently discarding the data key and the encrypted data key;
a tape storage library for generating a list of a plurality of valid key labels provided by at least one key manager;
a tape drive for securely receiving the data key from the key manager and for encoding data with the data key to form encoded data; and
a removable storage cartridge for storing the encoded data and for storing the encrypted data key in one or more locations on the removable storage cartridge.

18. The storage system of claim 17, where the key manager securely transfers the data key to the tape drive by encrypting the data key with a session key to form a session encrypted key that can be decrypted by the tape drive to extract the data key.

19. The storage system of claim 17, where the key manager uses a public key cryptography technique to wrap the data key with an encrypting key to generate the encrypted data key that is transferred through the tape drive for storage in one or more locations on the removable storage cartridge.

20. A tamper-resistant data storage cartridge, comprising:
a housing;
a re-writable recording medium contained within the housing; and
one or more encrypted data keys comprising respective valid key labels stored on the recording medium, where each encrypted data key is formed by encrypting a data key with a key encrypting key and where the data key is used to encrypt data for storage on the recording medium.

21. The data storage cartridge of claim 20, further comprising a cartridge memory contained within the housing, the cartridge memory having one or more encrypted data keys stored therein.

22. The data storage cartridge of claim 20, where the recording medium comprises a magnetic tape comprising a user data area and a non-user data area, where the one or more encrypted data keys are stored to one or more locations in the non-user data area of the magnetic tape.
